(19) United States
(12) Patent Application Publication
(10) Pub. No.: US 2013/0335996 A1
(43) Pub. Date: Dec. 19, 2013

(54) ILLUMINATION DEVICE HAVING TWO LIGHT SOURCES WITH ROTATIONAL AND PLANAR MOVEMENT CAPABILITIES

(71) Applicant: Shanghai Raylin International Trade Co., Ltd., Ninghai (CN)

(72) Inventors: BIN YAO, Shanghai (CN); Xing Wei Liu, Shanghai (CN)

(73) Assignee: Shanghai Raylin International Trade Co., Ltd.

(21) Appl. No.: 13/919,497

(22) Filed: Jun. 17, 2013

Related U.S. Application Data
(60) Provisional application No. 61/689,969, filed on Jun. 18, 2012.

(51) Int. Cl. F21V 21/06; F21L 4/04

(52) U.S. Cl. CPC F21V 21/06; F21L 4/04
USPC 362/581

(57) ABSTRACT

A portable illumination device having two directable light sources each having rotational and planar (i.e., pivotal) movement capabilities. Each light source is housed in an enclosed housing assembly attached at one end to a power source enclosed in a handle casing for providing power to the light sources, a switch mechanism enabling a user to selectively actuate or deactuate one and/or both light source arrays, a magnet base capable of being mounted on a metal platform, and multiple hooks for suspension.

### BACKGROUND OF THE INVENTION

1. The Field of the Invention

The present invention generally relates to a portable illumination device having two directable light sources, each having rotational and planar (i.e., pivotal) movement capabilities. More specifically, the present invention is directed to an illumination device having two light sources which are capable of 360° rotational and 90° planar movement capabilities.

2. Background and Related Art

Conventional handheld illumination devices are well known in the prior art and have been in use to provide portable illumination for decades. Typical handheld illumination devices, however, are incapable of directing illumination without the need to reposition the device itself. Handheld illumination devices with flexible or adjustable light source, on the other hand, utilize a single light source to direct illumination, thereby limiting the illumination of the light source to a single area.

Thus there is a need for a compact, lightweight illumination device capable of directing illumination in two different directions without the need to reposition the device itself.

### SUMMARY OF INVENTION

The present invention solves the above problems and provides a portable illumination device with directable light sources capable of functioning as a spot or radial illumination device. To achieve these and other advantages, and in accordance with the purpose of the invention as embodied and described more fully herein, the present invention comprises two light sources with each housed in a elongated, enclosed housing assembly, which is attached to a handle, encasing the power source, in a “Y-shape” configuration. Reflectors are employed in the enclosed housing assembly allowing the capability of directing illumination. The two enclosed housing assemblies are attached to the device handle at one end, thus allowing for 360° rotational and 90° planar movement. A switch mechanism on the handle casing enables a user to selectively actuate or deactuate one and/or both light sources. The invention may also include a magnetized base for mounting on metal surfaces and multiple hooks for suspension.

Another aspect of the present invention is to provide radial illumination. Because the two light sources are positioned in a collapsible Y-shape configuration, and each light source is capable of 360° rotation, the two light sources may be positioned in a parallel configuration with each light source directing illumination outward to achieve radial illumination.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a perspective view of an exemplary embodiment of the present invention (frontal view); and

FIG. 2 illustrates a perspective view of an exemplary embodiment of the present invention (lateral view).

### DETAILED DESCRIPTION OF THE INVENTION

### Reference Numerals in the Drawings

| | |
|---|---|
| 1 | magnet |
| 2 | base cover |
| 3 | base |
| 4 | power source |
| 5 | electronic/circuit control unit/board |
| 6 | pivot/swivel arrangement |
| 7 | electrical connection board |
| 8 | rotational arrangement |
| 9 | rotational locking mechanism |
| 10 | spring mechanism |
| 11 | light source array tube holder |
| 12 | light reflector |
| 13 | light source housing assembly |
| 14 | light array mounting/reflector board |
| 15 | light emitting diodes and/or |
| | light emission sources |
| 16 | planar locking mechanism |
| 17 | light source array tube housing |
| 18 | top cape/connect point for hook |
| 19 | light source array tube holder |
| 20 | hook |
| 21 | switch mechanism |
| 22 | power indicator |
| 23 | lower handle housing cover |
| 24 | upper handle housing cover |
| 25 | bottom/handle hook |
| 26 | handle cover |
| 27 | holding/mounting plate |

As stated above, the present invention generally relates to an portable illumination device having two light sources that each light source may be planarly and rotationally positioned by a user. More specifically, the present invention is directed to a portable illumination device having two directable light sources each having rotational and planar (i.e., pivotal) movement capabilities. Each light source is housed in an enclosed housing assembly attached at one end to a power source enclosed in a handle casing for providing power to the light sources, a switch mechanism enabling a user to selectively actuate or deactuate one and/or both light source arrays, a magnet base capable of being mounted on a metal platform, and multiple hooks for suspension.

In the disclosure and in the claims the term “hook” refers to any component or device capable of position the present invention for hands-free operation, including a strap, latch, clip, magnet, etc.

In the disclosure and in the claims the term “light source” refers to any component or device capable of emitting light, including a light bulb, a light emitting diode (“LED”), laser, etc., and is an example of a means for providing illumination, which may further comprise a reflector that either concentrates or diffuses the illumination emitted from the light source.

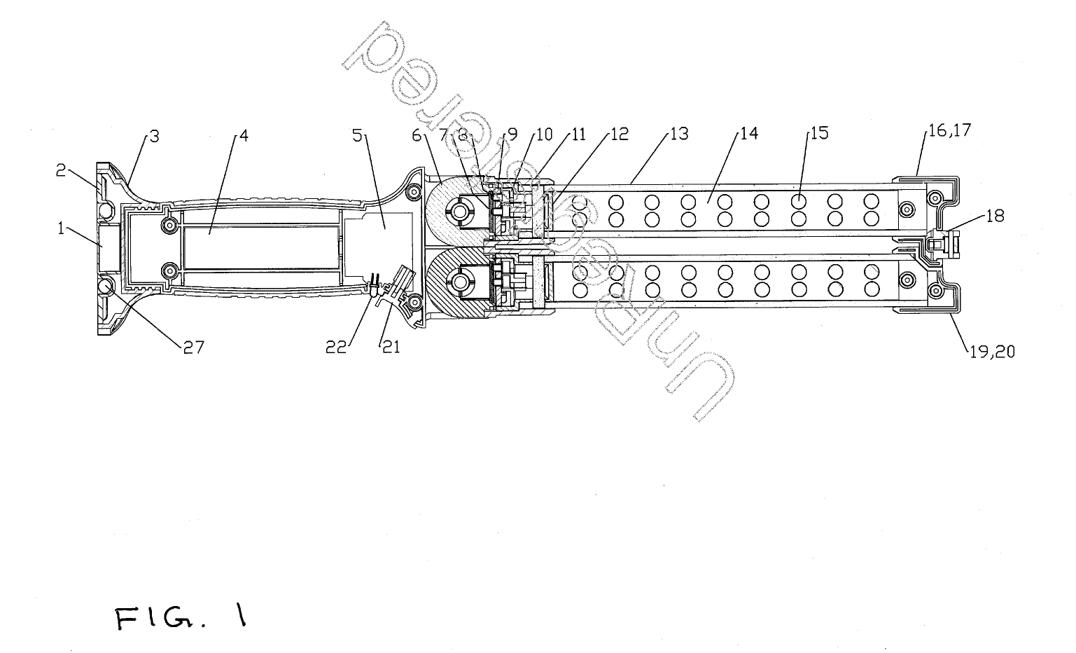

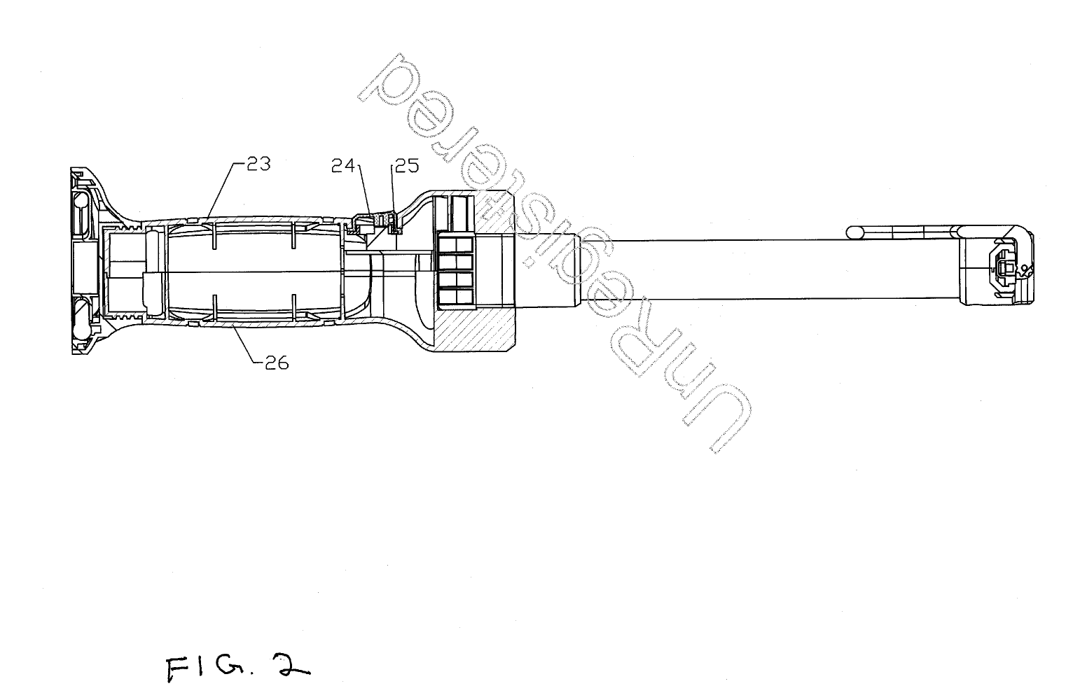

While FIGS. 1-2 are intended to be illustrative, embodiments of the present invention embrace portable, illumination device having a variety different shapes and sizes, a variety of different circuits, and/or a variety of different components to implement the features of the present invention.

FIG. 1 shows a perspective view of the present invention in an assembled state. Light source components (e.g., emitting diodes) 15 are arranged on the light reflector board 14 housed in the light source housing assembly 13. Reflectors are employed in the enclosed housing assembly allowing the capability of directing illumination. Although the present invention is described as including a generally elongated, rectangular shape for the light source housing assembly 13, it will be appreciated by those skilled in the art that light source housing assembly 13 may take other forms, shapes, and dimensions without departing from the scope of the invention.

The rotational arrangement 8 allows each light source housing assembly 13 to rotate 360°. The rotational mechanism 9 allows each light source housing assembly 13 to be selectively positionable and have a wide range of positioning adjustability. The light source housing assemblies have a top cape 18 and are each pivotally connected to the handle which houses the power source 4, electronic/circuit control unit/board electronic/circuit control unit/board 5, switch mechanism 21, power indicator 22, holding mounting plate 27, and base 3, which preferably houses batteries for powering the light sources.

The pivot arrangement 6 allows a maximum of 180° positioning of the two light source housing assemblies (maximum of 90° pivot for each housing assembly). The pivot locking mechanism 16 allows each light source housing assembly 13 to be selectively positionable and have a wide range of positioning adjustability.

The hook 20 provides the invention suspension capability. Although the present invention is described as including two hooks (one at each end), it should be appreciated by those skilled in the art that additional hooks may be employed and may also take other forms, shapes, and dimensions without departing from the scope of the invention.

The magnet 1 located behind the base cover 2 at the base 3 allows hands-free illumination using the invention. In the preferred embodiment, a DC power source for the invention is a conventional battery power source housed in power source 4. Alternatively AC power source having a similar capacity may be appreciated.

FIG. 2 shows a perspective view of the present invention in an assembled state.

1. A portable illumination device comprising:
a power source;
a body in which the power source is housed;
two light source array tubes, arranged in a pivotable Y-shape configuration, each having illumination means encapsulated in the tube, wherein the means for directing the illumination comprising a reflector configured within each tube such that light is reflected away from reflecting surfaces;
means electrically connecting the power source to the light source array tubes; and
a base structural component for connecting to one end of each light source array tube, having both pivotal and rotational means capable of independent rotational and planar movement capabilities, and position locking means to selectively position each light source array tube both planarly and rotationally in order to direct illumination.

2. The device as claimed in claim 1, wherein the body in which the power source is housed comprises an electrical circuit electrically coupled to the power source, the electrical circuit comprising means for selectively actuating and de-actuating each or both light sources.

3. The device as claimed in claim 2, wherein the illumination means comprises a plurality of light emitting elements selected from the group consisting light emitting diodes, lamps, laser diodes, and combinations thereof arranged in a longitudinal direction.

4. The device as claimed in claim 3, further comprises a handle arranged longitudinally of said body housing the power source.

5. The device as claimed in claim 4, wherein the body in which the power source is housed further comprising means connected to said tube holder for suspending the device.

6. The device as claimed in claims 3, 4, and 5, further comprises a mounting base at the end of said body housing the power source for attachment means selected from the group consisting of strap, latch, clip, magnet, and combinations thereof.

7. A hand-held illumination device comprising:
a body in which the power source is received;
two light sources, arranged parallelly, each having illumination means encapsulated in housing assembly, wherein the means for directing the illumination comprising a reflector configured within each housing assembly such that light is reflected away from reflecting surfaces;
means electrically connecting the power source to the light sources; and
a base structural component for connecting to one end of each light source, having a swivel means capable of independent rotational and planar movement capabilities, and position locking means to selectively position each light source array tube both planarly and rotationally in order to direct illumination.

8. The device as claimed in claim 7, wherein said body comprises an electrical circuit electrically coupled to the power source, the electrical circuit comprising means for selectively actuating and de-actuating each or both light sources.

9. The device as claimed in claim 8, wherein the illumination means comprises a plurality of light emitting elements selected from the group consisting light emitting diodes, lamps, laser diodes, and combinations thereof arranged in a longitudinal direction.

10. The device as claimed in claim 9, further comprises a handle arranged longitudinally of said body which power source is received.

11. The device as claimed in claim 10, wherein the body in which the power source is received further comprising means connected to said handle for suspending the device.

12. The device as claimed in claims 9, 10, and 11, further comprises a mounting base at the end of said body for attachment means selected from the group consisting of strap, latch, clip, magnet, and combinations thereof.
